(19) United States
(12) Patent Application Publication
(10) Pub. No.: US 2005/0247360 A1
(43) Pub. Date: Nov. 10, 2005

(54) Hydraulic reservoir in particular a membrane reservoir

(75) Inventors: Herbert Baltes, Losheim (DE); Gernot Rupp, Eppelborn (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: HYDAC TECHNOLOGY GMBH, SULZBACH/ SAAR (DE)

(21) Appl. No.: 10/519,091

(22) PCT Filed: May 13, 2003
(86) PCT No.: PCT/EP03/04973

§ 371 Date: Dec. 23, 2004

(30) Foreign Application Priority Data
Jul. 9, 2002 (DE) 102-30-743.1

(51) Int. Cl. F16L 55/04

(52) U.S. Cl. 138/30

(57) ABSTRACT

The invention relates to a hydraulic reservoir in particular a membrane reservoir, with a gas inlet body (12) which may be connected to parts of the reservoir housing and which comprises at least one mounting surface (28) for an elastically flexible separating element (16), which separates two chambers arranged within the reservoir housing from each other. The separating element (16) comprises a edge reinforcement (30) formed by material thickening to give a fixing edge for that part with the corresponding mounting surface (28) of the gas inlet body (12). Failures at the position of the fixing of the separation element to the hydraulic reservoir are avoided, despite high loading of the separating element under working conditions for the reservoir, whereby the edge reinforcement (30) is provided with a convex guide surface on the side thereof facing the gas inlet body (12) in contact with the corresponding mounting surface (28), which is at least partly concave in embodiment to match said unit.

The invention relates to a hydraulic accumulator, a bladder accumulator in particular, having a gas inlet element which may be connected to parts of the accumulator housing and which has at least one mounting surface for an elastically flexible separating element which separates from each other two chambers positioned inside the accumulator housing, the separating element having an edge reinforcement in the form of thickening of the material to form a fastening edge for the respective contact with the associated mounting surface of the gas inlet element.

Hydraulic accumulators of this type, which are preferred for use in hydraulic systems, perform a variety of functions, especially in the areas of energy storage, emergency actuation of assemblies, shock absorption, pulsation damping, etc. The general principle of operation of hydraulic accumulators is that of storage of compression energy, while the mode of operation of such accumulators having separating elements is based on the compressibility of a gas which is received into the gas chamber of the accumulator and is used for variable liquid storage inside the liquid chamber of the accumulator, the separating element separating the gas chamber from the liquid chamber and the liquid chamber being periodically connected to a hydraulic circuit so that when the pressure increases the gas is compressed on the gas side and when the pressure drops on the fluid side the compressed gas may expand and as a result the liquid stored is again forced into the hydraulic circuit.

Hydraulic accumulators with a separating element are in general divided into bladder accumulators, diaphragm accumulators, and piston accumulators, the present invention being employed by special preference in bladder accumulators which are provided with an elastically flexible separating element, preferably one in the form of a separating accumulator bladder. The accumulator bladder, in the form of a separating diaphragm, is charged periodically by the gas valve positioned on the upper part of the accumulator, which forms a sort of gas inlet element. The liquid valve mounted on the lower end of the hydraulic accumulator primarily prevents drawing of the accumulator bladder out by suction as the fluid flows out. The separating element in the form of the accumulator bladder is subjected to very high pressure change stresses and accordingly is highly stressed. The separating element is essentially kept open in the direction of the fluid side of the hydraulic accumulator and acts directly on the fluid side of the accumulator. At the opposite end, on the other hand, the separating element is rigidly connected to the gas inlet element, a reinforced edge in the form of thickening of the material being retained by clamping between the gas inlet element and the associated interior wall elements of the accumulator housing. In order to achieve good retention, in the disclosed solutions additional provision is made such that diaphragm parts of the accumulator bladder extend below the bottom of the gas inlet element, the entire area of which, except for an inlet and an outlet opening, is attached to the bottom of this gas inlet element. The fastening force may be further increased by gluing or vulcanizing the gas inlet element in the form of the gas valve in the opening of the separating element, preferably in the form of the accumulator bladder.

Despite the well tested procedure of fastening the separating element inside the housing of the hydraulic accumulator, failure of the entire hydraulic accumulator may occur as a result of processes of separation of the separating element by tearing which may occur precisely in the areas in which it is fastened. Failure of the fastening option is also possible in the event of vulcanizing of the gas inlet element into the unobstructed opening in the separating element, in particular as a result of the high alternating stresses in this separating element. It has also been found that unintentionally high stresses at the site of connection involving the risk of failure may occur as a result of the type of fastening described in the foregoing.

On the basis of this state of the art, the object of the invention is to effect further improvement in the known hydraulic accumulators, bladder accumulators in particular, so that, despite the high stresses to which the separating element is subjected during operation of the accumulator, instances of failure are prevented at the site of the fastening of the separating element to the hydraulic accumulator. The object as thus formulated is attained by means of a hydraulic accumulator having the characteristics specified in claim 1 in its entirety.

In that, as specified in the characterizing part of claim 1, the edge reinforcement is provided with a convex guide surface on its side facing the gas inlet element, which side is in contact with an associated mounting surface which is configured to be at least in part concave for the respective mounting, both a reliable possibility of fastening the separating element on the hydraulic accumulator housing is achieved and the fastening in question is effected by a gentle method, which does not harm the edge reinforcement and so tends to lengthen the service life of the connection. As a result of the convexity of the guide surface of the separating element, an annular surface in contact with the associated mounting surface of the gas inlet element, a sort of articulation is achieved and the separating element may correspondingly develop around the articulation and execute restricted movements, without introduction of harmful forces into the fastening point.

It is especially advantageous for formation of the articulation in question for the convex guide surface of the separating element to effect transition in the direction of its bottom partly into a concave development surface.

In one preferred embodiment of the hydraulic accumulator claimed for the invention the mounting surface of the gas inlet element communicates with a discharge slope, the angle of inclination of which encloses an acute angle with an imaginary plane transverse to the longitudinal axis of the hydraulic accumulator. On the basis of the respective configuration there is created for movement of the separating element a sort of free running surface which makes it possible for the separating diaphragm to be oriented in the direction of the discharge slope in question even in the event of very high expansion stresses, so that gentle movement of the separating element is made possible without introducing forces harmful to the fastening point.

Provision preferably is made such that the discharge slope of the gas inlet element undergoes transition in the direction of its bottom component into a camber designed to be convex.

If in another preferred configuration of an embodiment of the hydraulic accumulator claimed for the invention the discharge slope is provided with a support for the edge reinforcement with its convex guide surface, such provision makes certain that the fastening point illustrated cannot be unintentionally loosened when the separating element is subjected to extreme stresses. The support in question rather ensures that the edge reinforcement will remain in its fixed position at the fastening point.

In another preferred embodiment of the hydraulic accumulator claimed for the invention, the edge reinforcement has additional reinforcement on the side facing the accumulator housing. After the hydraulic accumulator has been assembled, this additional reinforcement is tightly fitted between at least one of the mounting surfaces of the gas inlet element and the associated wall component of the accumulator housing. Despite the increase in the force applied in the area of connection in question, care is nevertheless taken by way of the additional reinforcement that stress on the connection as a whole is relieved and that the compressive and tensile forces introduced into the separating element cannot have a harmful effect on the area of the connection point, so that incidents of failure are accordingly significantly reduced. It is a surprise to the expert in the field of hydraulic accumulators to learn that, despite increase in the forces of application in the area of fastening, relief of the forces introduced rather occurs in this area, and, in addition to the increased reliability of retention, processes of tearing of the elastic separating element are largely prevented in this area. A contribution to this result is made by the circumstance that the forces of application introduced in the area of transition between parts of the accumulator housing and the additional reinforcement of the separating element are jointly absorbed by the concave associated mounting surface of the gas inlet element so as to prevent damage to the separating element.

In another preferred embodiment of the hydraulic accumulator claimed for the invention, the additional reinforcement is in the form of a reinforcing ring which is offset to the back from the open end of the separating element or effects transition to a plane common with that of this separating element. Provision preferably is made such that the reinforcing ring is in the form of a ridge which is an integral part of the separating element and is semicircular, rectangular, or triangular in cross-section. Selection of the respective geometric form of the ridge makes it possible to achieve gentle linear or planiform contact between the separating element and the associated parts of the accumulator housing, so that the fastening may be adapted with precision and certainty to the stresses occurring in the individual instance as a function of the application problem involved which is to be solved.

Provision preferably is made such that the open end of the respective fastening ridge is provided with a convex camber; this affords the advantage that transitional areas with sharp edges are avoided, ones with might favor harmful introduction of forces into the area of the fastening edge.

In another preferred embodiment of the hydraulic accumulator claimed for the invention, the additional reinforcement of the separating element is replaced by provision of a recess on the interior side of the associated parts of the accumulator housing, so that adequate space is provided for seating of the edge reinforcement of the separating element. The additional reinforcement may rest on surfaces of the recess and thus ensure retention of the fastening edge in its position, as well as prevention of impermissibly high compressive forces on the fastening edge of the separating element. The possibility also exists of support of the accumulator housing parts by separating element segments positioned farther outward in the radial direction; this as well has been found to be favorable for introduction of forces to the site of transition between the separating element and the fastening edge.

In one especially preferred embodiment of the hydraulic accumulator claimed for the invention, the course of curvature of the accumulator housing in the interior of the latter in the area of contact with the separating element is steeper than that of the separating element in the unactuated initial state, the respective curvature being designed to be steeper than that of the separating element when fastened. The different courses of curvature of wall components of the accumulator housing and of the separating element also make it possible to achieve full-area contact in the area of contact when the accumulator has been actuated, and as a result of the frictional forces which occur, these forces seeking to retain the separating diaphragm on the inside of the accumulator housing on the fastening edge in the area of transition, the respective fastening components are relieved of stresses, this resulting in significant additional increase in the service life of the hydraulic accumulator.

The hydraulic accumulator claimed for the invention will now be described in greater detail below with the aid of three exemplary embodiments illustrated in the drawings, in which, in the form of diagrams not drawn to scale,

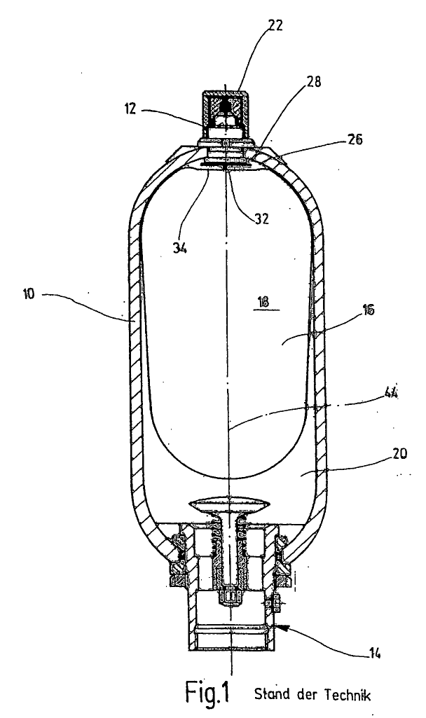

FIG. 1 shows a bladder accumulator (hydraulic accumulator) such as is of the state of the art, partly as a front view and partly in longitudinal section;

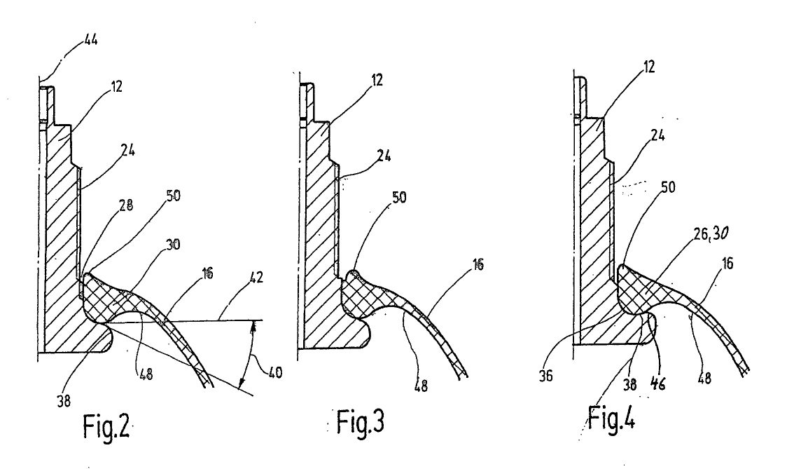

FIGS. 2 to 4 show, in cross-section, three different options for connecting the respective separating element to the associated gas inlet element;

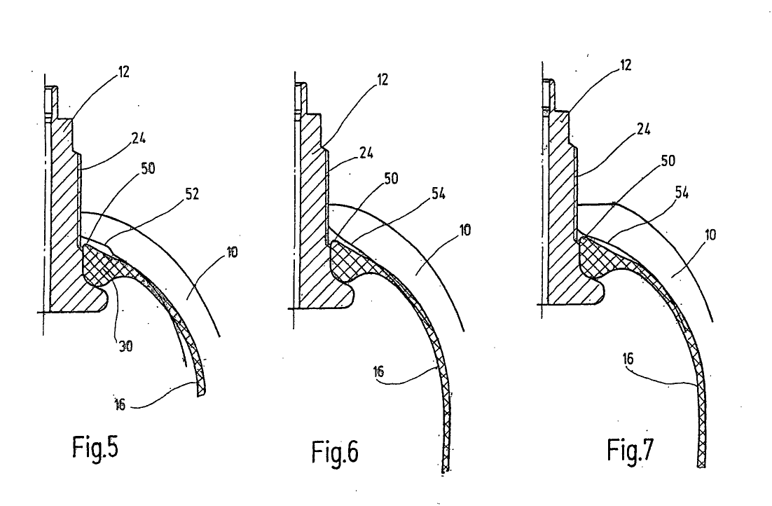

FIGS. 5, 6, and 7 shown three different options for fastening associated parts of the accumulator as shown in FIG. 2 at the fastening point.

The state-of-the art hydraulic accumulator, in the form of a bladder accumulator, is published in the book issued by Mannesmann-Rexroth GmbH ADer Hydraulik-Trainer@ [The Hydraulics Trainer], Volume 3, first edition, page 100. This known hydraulic accumulator has an accumulator housing 10, on the upper side of which there is mounted a gas inlet element 12 in the form of a conventional gas valve provided for this purpose. The accumulator housing 10 is provided on its lower side with a poppet valve assembly designated as a whole as 14. A separating element 16 in the form of an accumulator bladder of elastomer material (rubber diaphragm material) is mounted inside the accumulator housing 10. The separating element 16 in question divides the hydraulic accumulator into a gas chamber 18 and a fluid chamber 20. When fluid flows in by way of the poppet valve assembly 14, the working gas, mostly in the form of nitrogen gas, enclosed in the separating element 16 so as to be fluid-tight is compressed and the energy thus stored on the gas side may later be delivered if necessary to the fluid side of the accumulator and thus in turn to the fluid chamber 20, the associated separating element 16 then being expanded by the action of the working gas. If the accumulator is fully emptied of fluid on its fluid side, the separating element 16 can actuate the poppet valve assembly 14 by way of its lower side and the poppet valve is closed in the conventional manner against the force of a reset spring. The respective structure of a hydraulic or bladder accumulator is a conventional one, and accordingly all the details of such accumulators will not be discussed at this point.

The gas inlet element 12 in the form of the gas valve is provided with a cover 22 in the form of a cap and, as is shown in FIG. 1, the gas inlet element 12 is designed to engage the accumulator housing 10; the gas inlet element 12 may for this purpose be screwed into the free opening of the accumulator housing 10 by way of conventional external threading 24 (see FIG. 2 and following). In the known solution the separating element 16 is provided with the associated mounting surface 28 of the gas inlet element 12 to form a fastening edge 26 for the respective assembly, the fastening edge 26 having an edge reinforcement 30 in the form of thickening of the material in this area. In the case of the known solution shown in FIG. 1, an additional fastening option is also provided in that, on the lower side (bottom part) of the gas inlet element 12 the separating element 16 extends below the respective end as far as an inlet opening 32 and in doing so forms a flat support surface 34. Despite this additional support surface 34, in the event of high compression and application of tensile stress to the separating element 16, it is possible for this element to be torn off in the area of transition to the fastening edge 26 or for it to become porous at these sites, something which in both instances may result in failure of the entire hydraulic accumulator. If one is reluctant to wait for the respective event of failure, the separating element 16 in the form of the accumulator bladder is to be replaced at prescribed maintenance intervals by decommissioning the hydraulic accumulator.

In order to prevent the failure in question, provision is made by the solution provided by the invention as illustrated in FIG. 2 such that the edge reinforcement 30 is provided on its side facing the gas inlet element 12 with a convex guide surface 36 which is in contact with the associated mounting surface 28, which is configured to be at least in part concave. The concave mounting surface 28 of the gas inlet element 12 communicates with an outlet slope 38, the angle of inclination 40 of which encloses an acute angle, preferably of approximately 25°, with an imaginary plane 42 extending transversely to the longitudinal axis of the hydraulic accumulator.

As is shown in FIG. 4, in order to increase the retention forces for the fastening edge 26, in a modified embodiment the respective outlet slope 38 may be provided with a support 46 which secures the edge reinforcement 30 with its convex guide surface 36.

In the area of transition between the separating diaphragm 16 as accumulator bladder and the edge reinforcement 30, as is shown in FIG. 2 and following, the convex guide surface 36 effects transition to a concave development surface 48. The respective development surface 48 makes it possible, even in the event of strong compressive movements of the separating membrane 16, for this membrane to develop on the convex outlet slope 38 of the gas inlet element 12 in order thus to protect the clamping point on the edge reinforcement 30 from harmful introduction of forces. Consequently, the transition from convex guide surface 36 to concave mounting surface 28 of the gas inlet element 12 forms a sort of articulation or hinge point so that the separating diaphragm 16 may develop gently between gas inlet element 12 and inside of the accumulator housing 10. Even if the gas inlet element 12 is configured with a support 46, as is shown in FIG. 4, the separating membrane 16 may develop around this support with precision without harmful kinks and introduction of impermissibly high tension into the separating element 16.

In one especially preferred embodiment, provision is made such that the edge reinforcement 30 has on its side facing the accumulator housing 10 an additional reinforcement 50 which, when the accumulator has been assembled, is compressed between at least one of the mounting surfaces 28 of the gas inlet element 12 and the interior wall elements of the accumulator housing 10. In the embodiment shown in FIGS. 2 and 4, the additional reinforcement 50 consists of a reinforcing ring or bead which is more or less triangular in cross-section, the open end of the additional reinforcement 50 being provided with a camber toward the exterior, in order thus to obtain two-dimensional sealing contact with associated internal wall elements of the accumulator housing at the point of fastening. Consequently, in these embodiments the additional reinforcement 50 communicates in a common plane with the parts of the guide surface of the fastening edge 26 which are oriented in parallel with the longitudinal axis 44 of the accumulator housing 10. In the form of embodiment shown in FIG. 3, the reinforcing ring is configured to be semicircular in cross-section and is mounted so as to be offset to the back from the frontal guide surface opposite the gas inlet element 12. Because of the outline on the external circumference side of the additional reinforcement 50, two-dimensional contact with the associated interior wall elements of the accumulator housing is ensured, so that reliable sealing is ensured in these areas as well.

FIG. 5 and following illustrate installation of the configuration shown in FIG. 2 inside the accumulator housing 10 of the hydraulic accumulator as a whole shown in FIG. 1, after this housing has been mounted. For the sake of greater clarity of illustration, however, the accumulator housing part 10 in FIGS. 5, 6, and 7, is not shown in its position after having been screwed tightly onto the gas inlet element 12, so that the relationships at the point of clamping may be more clearly illustrated.

In the embodiment shown in FIG. 5, the interior of the accumulator housing 10 has in the area of application with the edge reinforcement 30 a recess 52 which is formed by reducing the wall cross-section of the accumulator housing 10 in the direction of the open end of the opening in this housing. After installation the edge reinforcement 30 with its bead-like widened area accordingly rests also on the interior wall of the recess 52 in the radial direction, so that the fastening edge 26 is securely fastened to the gas inlet element 12. In the embodiment illustrated in FIGS. 6 and 7 the recess 52 shown in FIG. 5 is in the form of corresponding recess slopes 54, but these slopes exert essentially the same effect and ensure all-over contact over large areas of the accumulator housing 10 in the area of the fastening point, along with correspondingly high frictional forces between separating element 16 and accumulator housing 10, something which contributes to more secure fastening.

As shown also in FIG. 5 and following, the course of curvature of the accumulator housing 10 in the area of contact with the edge reinforcement 30 is steeper than the separating element 16 in the initial state before actuation, the curvature in question being designed to be steeper than that of the separating element 16 after it has been fastened. In order to illustrate the radii of curvature, in the drawings in FIGS. 5, 6, and 7, the separating element 16 below its fastening edge 26 is shown symbolically to extend in part inside the accumulator housing 10, while the actual relationships are such that the upper side of the elastomer separating element 16 is guided in this area over a predetermined frictional section along the inside of the accumulator housing 10. The separating element 16 is relieved of forces of friction by way of the frictional stretch as configured on its fastening edge 26, with the result that peaks of force introduction are reliably absorbed in this way before they reach the point of clamping and can exert their effect. This last-named circumstance significantly lengthens the service life of the clamping feature of the separating element 16 inside a variety of hydraulic accumulator housings.

In order to retain the gas inlet element 12 in its installed position on the open end of the separating element 16, provision preferably is made such that the diameter chosen for the free end of the separating element 16, bounded by the fastening edge 26, is significantly smaller than the external circumference of the gas inlet element 12 below the external threading 24. Consequently, when the gas inlet element 12 has been introduced, the free, open end of the separating element 16 is expanded and, as a result of the elastic rubber tension, the gas inlet element 12 is immobilized in its installed position in the separating element 16. As an alternative or in addition, provision may also be made such that permanent mounting of the separating element 16 on the gas inlet element 12 is achieved by way of a bonding agent (primer) or an adhesive compound.

If the separating element 16 is pretensioned before being mounted on the gas inlet element 12, a reliable barrier is formed the effect of which may be increased by way of the additional reinforcement 50, so that, for example, if aggressive fluid media are used in place of the conventional hydraulic medium, the gas side is securely separated from the fluid side and in this way damage to the gas inlet element 12 by the aggressive medium may also be prevented.

1. A hydraulic accumulator, a bladder accumulator in particular, having a gas inlet element (12) which may be connected to parts of the accumulator housing (10) and having at least one mounting surface (28) for an elastically flexible separating element (16) which separates from each other two chambers (18, 20) positioned inside the accumulator housing (10), the separating element (16) having an edge reinforcement (30) in the form of thickening of the material forming a fastening edge (26) for the respective contact with the associated mounting surface (28) of the gas inlet element (12), characterized in that the edge reinforcement (30) is provided on its side facing the gas inlet element (12) with a convex guide surface (36) which is in contact with the associated mounting surface (28) which is configured to be at least in part concave for the respective contact.

2. The hydraulic accumulator as claimed in claim 1, wherein the mounting surface (28), configured to be concave, of the gas inlet element (12) communicates with an outlet slope (38) the angle of inclination (40) of which encloses an acute angle with an imaginary plane (42) extending transversely to the longitudinal axis (44) of the hydraulic accumulator.

3. The hydraulic accumulator as claimed in claim 2, wherein the outlet slope (38) is provided with a support (46) for the edge reinforcement (30) with its convex guide surface (36).

4. The hydraulic accumulator as claimed in claim 1, wherein the edge reinforcement (30) has on its side facing the accumulator housing (10) an additional reinforcement (50) which, when the accumulator has been assembled, is compressed between at least one of the mounting surfaces (28) of the gas inlet element (12) and the associated wall elements of the accumulator housing (10).

5. The hydraulic accumulator as claimed in claim 4, wherein the additional reinforcement (50) is in the form of a reinforcing ring which is offset to the back from the open end of the separating element (16) or which effects transition at this open end to a common plane with the separating element (16).

6. The hydraulic accumulator as claimed in claim 5, wherein the reinforcing ring is in the form of a bead which, as an integral component of the separating element (16) is semicircular, rectangular, or triangular in cross-section.

7. The hydraulic accumulator as claimed in claim 6, wherein the free end of the bead is provided with a convex camber.

8. The hydraulic accumulator as claimed in claim 4, wherein, at the site of the additional reinforcement (50) of the separating element (16), the associated parts of the accumulator housing (10) are provided on their inside with a recess (52).

9. The hydraulic accumulator as claimed in claim 1, wherein the course of curvature of the accumulator housing (10) in the interior of the latter in the area of contact with the separating element (16) is steeper than that of the separating element (16) in the unactuated initial state, and wherein the respective curvature is designed to be steeper than that of the separating element (16) when fastened.
